(19) United States
(12) Patent Application Publication
(10) Pub. No.: US 2023/0119919 A1
(43) Pub. Date: Apr. 20, 2023

(54) SERVICE REALIZATION USING A SEGMENTED MPLS CONTROL PLANE

(71) Applicant: AT&T Intellectual Property I, L.P., Atlanta, GA (US)

(72) Inventors: James Uttaro, Staten Island, NY (US); Avinash Lingala, Edison, NJ (US); Qassim Badat, Piscataway, NJ (US)

(21) Appl. No.: 17/504,744

(22) Filed: Oct. 19, 2021

(51) Int. Cl. H04L 12/723; H04L 12/717; H04L 12/707

(52) U.S. Cl. CPC H04L 45/507; H04L 45/42; H04L 45/24

(57) ABSTRACT

A system in which a mapping function specific to a given provider edge may provide value added services. Said provider edge already uses label distribution protocol, resource reservation protocol, or the like.

### BACKGROUND

Conventionally service providers and others that run large networks have deployed traditional resource reservation protocol (RSVP)/label distribution protocol (LDP) design to facilitate multi-protocol label switching (MPLS). These designs are implemented in the network and have served a role. RSVP is used to create slicing in the network and can, without an independent controller, dynamically re-create needed tunnels when there is failure in the network.

This background information is provided to reveal information believed by the applicant to be of possible relevance. No admission is necessarily intended, nor should be construed, that any of the preceding information constitutes prior art.

### SUMMARY

A system is described whereby a mapping function specific to a given provider edge (PE) may provide value added services. Said PE should already participate in LDP, RSVP, or both. The PE may also participate in a segment routing (SR)-MPLS BGP signaled domain where PE labels and associated globally invariant labels are disseminated to the set of PEs needed to realize the service. The PE may map the LDP assigned label learned from its adjacencies to the SR label learned via border gateway protocol (BGP). When sending traffic, the PE may push the BGP route and the LDP label along with any service labels.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for using a segmented MPLS control plane.

FIG. 2 illustrates an exemplary method for using a segmented MPLS control plane.

FIG. 3 illustrates a schematic of an exemplary network device.

FIG. 4 illustrates an exemplary communication system that provides wireless telecommunication services over wireless communication networks.

### DETAILED DESCRIPTION

The disclosed subject matter may continue to take advantage of the conventional design in the core, while deploying segment routing (SR)-MPLS on the edge to create value added services. Example value added services may include content delivery networks (CDN), egress traffic peering selection, or service function chaining, among other things. Conventionally in order to use value added services, a service provider would need to: a) create mapping servers in the control and data plane; b) run SR/MPLS and existing MPLS (LDP, RSVP) as ships in the night; or c) migrate the network core to SR/MPLS. None of these meet the requirements that would maintain the RSVP infrastructure, no perturbation of the core (e.g., if a provider implemented a, b, or c, the provider would have to deploy new technology, such as SR/MPLS across the entire network as opposed to deploying only on the PEs). For clarity “ships in the night” may refer to both protocols running simultaneously; LDP and SR/MPLS are both running on the PE learning and advertising labels.

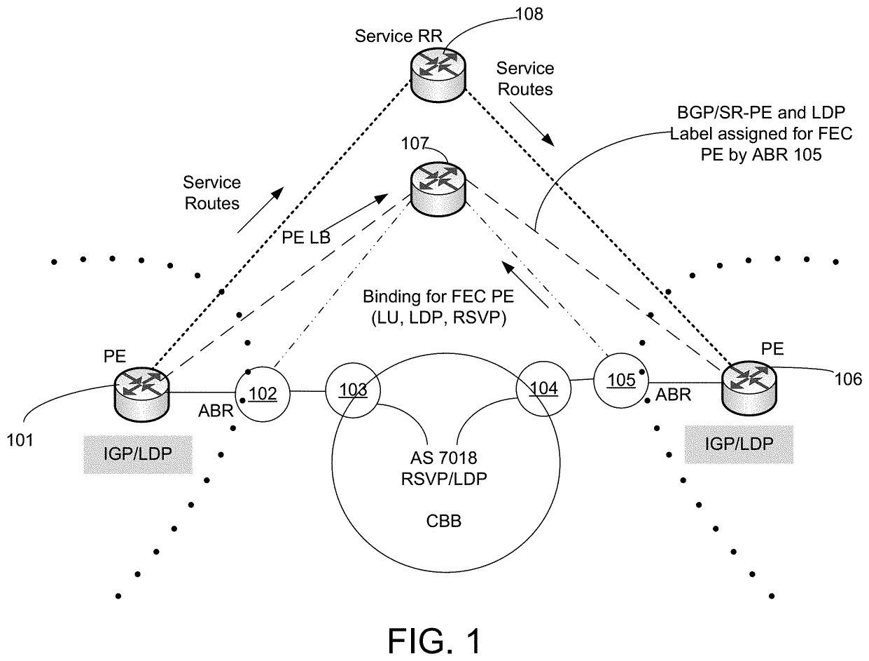

FIG. 1 illustrates an exemplary system for using a segmented MPLS control plane, among other things. System 100 may include multiple routing devices that create a routing network. The system may include provider edge router (PE) 101, area border router (ABR) 102, core router 103, core router 104, ABR 105, PE 106, segment routing (SR)-BGP route reflector (RR) 107, service RR 108. The device may be physical or logical. The devices of system 100 may be communicatively connected with each other and may use a routing protocol, such as BGP, label distribution protocol (LDP), or interior gateway protocol (IGP). In an example, SR-BGP label and LDP label may be assigned for forwarding equivalence class (FEC) PE by ABR 105, which is received by SR-BGP RR 107, and distributed to other ABRs (e.g., ABR 102) and PEs (e.g., PE 101 or PE 106).

The system allows the transport and service MPLS label bindings to be divorced. SR is used for edge services and can be used with any intermediate transport MPLS. Various network service functions availability may be exposed to customers using REST API that may allow for a customer to select flows to go through service functions (e.g., firewall, network address translation, deep packet inspection, etc.). With the use of service RR 108 in an SR-MPLS environment, the traffic to certain service functions may be steered as needed by customers. This system may interact with multiple services (e.g., virtual private network services or cloud services). SR-MPLS may help to efficiently engineer the content delivery network (CDN) traffic over certain egress points as needed.

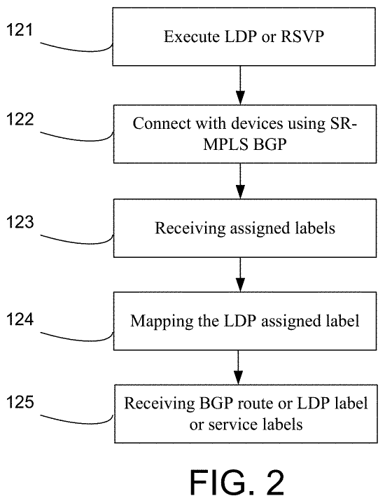

FIG. 2 illustrates an exemplary method for using a segmented MPLS control plane. At step 121, PE 106, PE 101, or other PEs in system 100 may be configured to execute LDP, RSVP, or the like. At step 122, various devices may be connected with in order for PEs (e.g., PE 106) to participate in a SR-MPLS BGP signaled domain. The labels of the PEs and associated globally invariant labels may be disseminated to the set of PEs used to realize the service. These labels may be disseminated using service RR 108 or SR-BGP RR 107. PEs may be updated to use BGP/SR (BGP-LU with Unique Label) on PEs. Internal Core Routers (e.g., ABR 105 or core router 104) may be unchanged.

At step 123, receiving, by PE 106, LDP assigned labels. These LDP assigned labels may be from SR-BGP RR 107. At step 124, mapping, by PE 106, the LDP assigned label learned from its adjacencies to the SR label learned via BGP or the like. PE 106 is learning an LDP label from the ABR for a NH (e.g., PE 106). PE 106 is also learning an SR Label from its BGP adjacency with the RR 107 in FIG. 1. At step 125, the BGP route and the LDP label along with service labels may be received or sent by PE 106. The service labels may come from customer devices using an API to update or turn on services and may be distributed by services RR 108. Services may be created using PE labels and service SR labels, while a controller (not shown) disseminates the labels.

The disclosed subject matter may allow a service provider to garner the benefit of RSVP in the core and SR/MPLS on the edge. This can be a powerful combination that can provide network services in the core (e.g., network slicing, priority/backup tunnel, in-network signaling etc.) and marry that with edge services (e.g., service function chaining—SFC, CDN, or egress peering). PEs and ABRs may need to be upgraded to support the disclosed subject matter, but the internal packet core network may remain unchanged. The disclosed subject matter may maintain integrity of best path selection from PE-to-PE, while path selection is opaque and uninterrupted by gateways. Other conventional solutions in the marketplace forces a network provider to select one solution or the other, which often requires an upgrade of the core network. In conventional systems, there may be a mapping of segment routing mapping servers (e.g., SR to RSVP required), intervening data plane mapping (e.g., SRV6 to SR-MPLS, etc.), or the like.

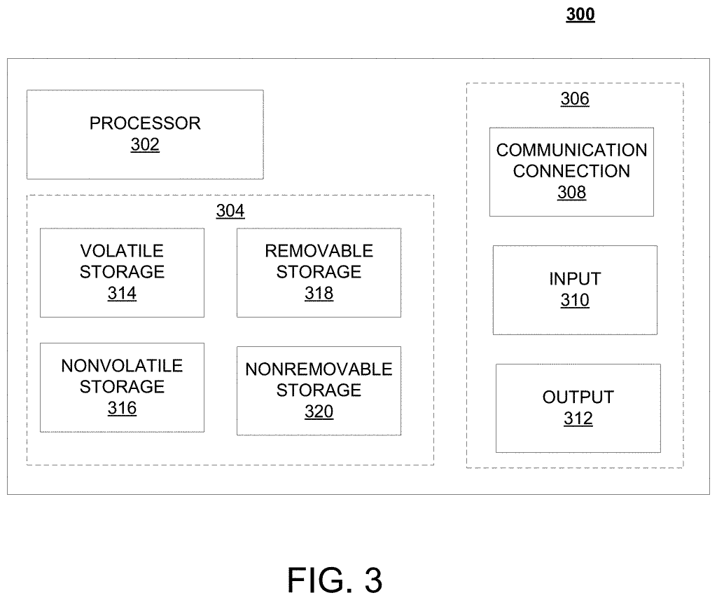

FIG. 3 is a block diagram of network device 300 that may be connected to or comprise a component of system 100. Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 3) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

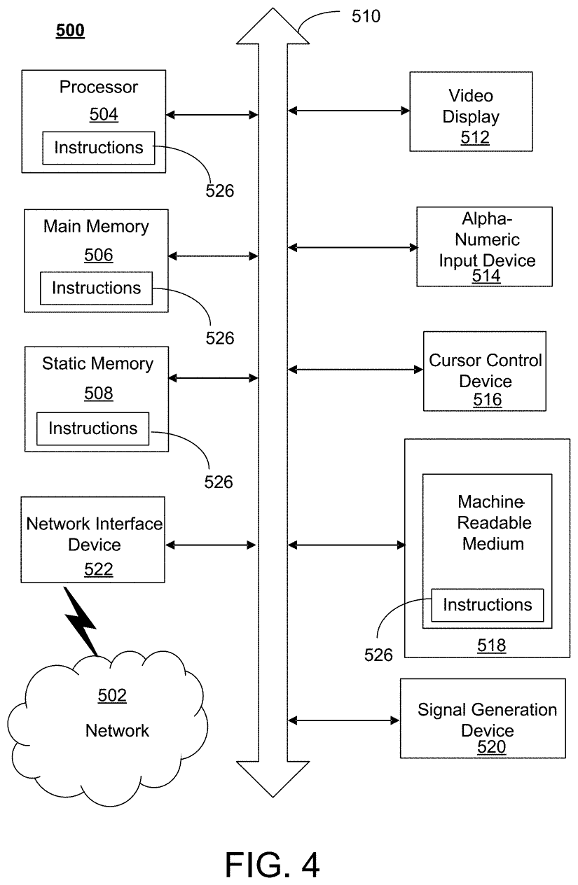

FIG. 4 depicts an exemplary diagrammatic representation of a machine in the form of a computer system 500 within which a set of instructions, when executed, may cause the machine to perform any one or more of the methods described above. One or more instances of the machine can operate, for example, as processor 302, PE 101, ABR 102, core router 103, core router 104, ABR 105, SR-BGP RR 107, service RR 108, and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

While examples of a system in which segmented MPLS control plane alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—using a segmented MPLS control plane—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for using a segmented MPLS control plane. A method, system, computer readable storage medium, or apparatus provides for executing (configured to execute) LDP or RSVP on a provider edge device; and participating in a SR-MPLS BGP signaled domain, wherein the labels of the PE and associated globally invariant labels are disseminated to the set of PEs used to realize the service. The method, system, computer readable storage medium, or apparatus provides for learning (obtaining), by the PE, LDP assigned label; and mapping, by the PE, the LDP assigned label learned from its adjacencies to the SR label learned via border gateway protocol (BGP). The method, system, computer readable storage medium, or apparatus provides for learning, by the PE, LDP assigned label, wherein the LDP assigned label is learned from adjacencies to the SR label learned via border gateway protocol (BGP); and mapping, by the PE, the LDP assigned label learned from its adjacencies to the SR label learned via border gateway protocol (BGP). The method, system, computer readable storage medium, or apparatus provides for sending, by the PE, the BGP route and the LDP label along with service labels. All combinations in this paragraph (including the removal or addition of steps) are contemplated in a manner that is consistent with the other portions of the detailed description.

1. A method comprising:
executing, by a processing system including a processor at a provider edge (PE) device, label distribution protocol (LDP) or resource reservation protocol (RSVP);
participating, by the processing system at the PE device, in a segment routing multi-protocol label switching (SR-MPLS) border gateway protocol (BGP) signaled domain, wherein labels of the PE device and associated globally invariant labels are disseminated to a set of PE devices used to realize services; and
receiving, by the processing system at the PE device, a segment routing (SR) label associated with a service from a service route reflector (RR) responsive to an interaction between the service and a customer device.

2. The method of claim 1, further comprising:
receiving, by the processing system at the PE device, an LDP assigned label; and
mapping, by the processing system at the PE device, the LDP assigned label learned from adjacencies to an SR label learned via BGP.

3. The method of claim 1, further comprising:
learning, by the processing system at the PE device, an LDP assigned label, wherein the LDP assigned label is learned from communicatively connected adjacent devices; and
mapping, by the processing system at the PE device, the LDP assigned label learned from its adjacencies to an SR label learned via BGP.

4. The method of claim 1, further comprising:
learning, by the processing system at the PE device, an LDP assigned label, wherein the LDP assigned label is learned from adjacencies to the an SR label learned via BGP; and
mapping, by the processing system at the PE device, the LDP assigned label learned from its adjacencies to the SR label learned via BGP.

5. The method of claim 1, wherein the interaction between the service and the customer device further comprises an application programming interface (API) call to update the service, to turn on the service, or a combination thereof.

6. An apparatus comprising:
a processor; and
a memory coupled with the processor, the memory storing executable instructions that when executed by the processor cause the processor to effectuate operations comprising:
executing label distribution protocol (LDP) or resource reservation protocol (RSVP) on a provider edge (PE) device; and
participating in a segment routing multi-protocol label switching (SR-MPLS) border gateway protocol (BGP) signaled domain, wherein labels of the PE device and associated globally invariant labels are disseminated to a set of PE devices used to realize services; and
receiving, at the PE device, a segment routing (SR) label associated with a service from a service route reflector (RR) responsive to an interaction between the service and a customer device.

7. The apparatus of claim 6, the operations further comprising:
receiving an LDP assigned label; and
mapping the LDP assigned label learned from adjacencies to an SR label learned via border gateway protocol (BGP).

8. The apparatus of claim 6, the operations further comprising:
learning an LDP assigned label, wherein the LDP assigned label is learned from communicatively connected adjacent devices; and
mapping the LDP assigned label learned from its adjacencies to an SR label learned via border gateway protocol (BGP).

9. The apparatus of claim 6, the operations further comprising:
learning an LDP assigned label, wherein the LDP assigned label is learned from adjacencies to an SR label learned via BGP; and
mapping the LDP assigned label learned from its adjacencies to the SR label learned via BGP.

10. The apparatus of claim 6, further comprising sending a BGP route and an LDP label along with the SR label associated with the service.

11. The apparatus of claim 6, wherein the apparatus comprises a provider edge device.

12. A computer readable storage medium storing computer executable instructions that when executed by a computing device cause said computing device to effectuate operations comprising:
executing label distribution protocol (LDP) or resource reservation protocol (RSVP) on a provider edge (PE) device;
participating in a segment routing multi-protocol label switching (SR-MPLS) border gateway protocol (BGP) signaled domain, wherein labels of the PE device and associated globally invariant labels are disseminated to a set of PE devices used to realize services; and
receiving, at the PE device, a segment routing (SR) label associated with a service from a service route reflector (RR) responsive to an interaction between the service and a customer device.

13. The computer readable storage medium of claim 12, the operations further comprising:
receiving an LDP assigned label; and
mapping the LDP assigned label learned from adjacencies to an SR label learned via BGP.

14. The computer readable storage medium of claim 12, the operations further comprising:
learning an LDP assigned label, wherein the LDP assigned label is learned from communicatively connected adjacent devices; and
mapping the LDP assigned label learned from its adjacencies to an SR label learned via BGP.

15. The computer readable storage medium of claim 12, the operations further comprising:
learning an LDP assigned label, wherein the LDP assigned label is learned from adjacencies to an SR label learned via BGP; and
mapping the LDP assigned label learned from its adjacencies to the SR label learned via BGP.

16. The computer readable storage medium of claim 12, further comprising sending a BGP route and an LDP label along with the SR label associated with the service.

17. The computer readable storage medium of claim 12, wherein the operations are executed by a provider edge router.

18. The apparatus of claim 6, wherein the interaction between the service and the customer device further comprises an application programming interface (API) call to update the service, to turn on the service, or a combination thereof.

19. The computer readable storage medium of claim 12, wherein the interaction between the service and the customer device further comprises a call to update the service, to turn on the service, or a combination thereof.

20. The computer readable storage medium of claim 19, wherein the call to update the service, to turn on the service, or a combination thereof comprises an application programming interface (API) call.
